(19) United States
(12) Patent Application Publication
(10) Pub. No.: US 2008/0312959 A1
(43) Pub. Date: Dec. 18, 2008

(54) Health Care Data Management System

(75) Inventors: Georg Hans Rose, Magdeburg (DE); Klaus Weidenhaupt, Wassenberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,083

(22) PCT Filed: Aug. 17, 2006
(86) PCT No.: PCT/IB2006/052846

§ 371 Date: Aug. 20, 2008

(30) Foreign Application Priority Data
Aug. 19, 2005 (EP) 05107620.6

(51) Int. Cl. G06Q 50/00

(52) U.S. Cl. 705/2

(57) ABSTRACT

The present invention is directed to a health care data management system comprising a workflow management system and a decision support system, as well as to a corresponding computer program product and a method. The decision support system comprises a probabilistic expert system for medical advice and is arranged to create a query to be sent to the workflow management system. It is also arranged to receive a corresponding answer determined by the workflow management system. This answer comprises entity allocation data relating to the allocation of an entity handled by the workflow management system. Furthermore, the decision support system is arranged to utilize the data as probabilistic input variable(s) for the expert system. Such a system has the advantage of combining up-to-date patient data and organisational data (resource allocation), which is managed by the workflow management system, with the profound medical expertise of a decision support system.

The present invention is directed to health care data management system and methods for their operation. The present invention is also directed to interfaces used in such health care data management systems as well as to computer program products carrying computer readable code defining health care data management systems.

Hospitals and health care centres nowadays are focusing more and more on computerized tools for improving the quality and the efficiency of health care. Two important classes of information technology systems employed to this end are Workflow Management Systems (WFMS) and Decision Support Systems (DSS). A decision support system is disclosed in U.S. Pat. No. 6,687,685 B1, which relates to a system and method of medical knowledge domain modelling and automated medical decision making, but does not mention workflow management systems.

### Workflow Management Systems

Workflow Management Systems have been in use for a couple of years in a wide variety of branches for controlling, monitoring, and optimizing routine procedures (e.g. processing of damage events in an insurance) in a computerized manner. The architecture of a WFMS comprises three essential core components:

### Workflow Model:

A workflow model is a representation of a plan of procedures and the structure of an organisation that is representable in a computer. The workflow model comprises a process model, in which the procedures are formalized, and an organisational model, in which the staff (availability, qualification, skills) and other resources (machines, devices etc.) are represented. The representation of the process model is usually done by means of flowchart formalisms or the like, which allow for a hierarchical structuring of procedures in subordinate activities. In general, the definition of procedures includes the declaration of input and output data types, as well as of the required resources. In combination with the organisational model the WFMS can allocate an activity to a specific person and verify, if the required resources are available at run time. The order of activities within the procedure is determined by means of a number of control structures (linear sequence, loops, branching, synchronisation, etc.). Decision points assume a particular role among the control structures. At a decision point, the process model has more than one possible following activity. Some systems offer a rule-based formalism by means of which conditions for the selection of one alternative can be specified and evaluated at run time. In reality however, often an explicit decision made by a user is necessary, which is not supported further by the process model.

### Workflow Engine:

The workflow engine controls and monitors the execution of workflow models by managing the execution state of each workflow instance. It determines the activities that are to be performed next and informs a user about pending activities. In the case of several concurrently executing workflow instances the workflow engine is in charge of the important task of scheduling, that is to plan and interdigitate the execution of activities in such a manner that an optimal resource utilisation is achieved.

### User Front End:

The user communicates via a computer-based user front end with the workflow engine. Often, the front end is organised as an agenda tool. In this agenda tool, the user may choose and launch activities that have been assigned to him/her. He or she may also enter information as to the progression state of the activity in the user front end, which information is transferred to the workflow engine. Often the WFMS is integrated with the remainder of the information technology infrastructure in a way that a complete workflow context is placed at the user's disposal at the launch of an activity. The workflow context is provided automatically and includes all applications and data that are required for the execution of the activity. Although up to now workflow management systems have been used mainly in business environments, also in the field of health care efforts are made to adapt treatment guidelines, which are currently available in paperwork only for some diseases, to be available in an electronic form as workflow models and to be supported by workflow management systems, often in a web-based manner. Such an approach is expected to achieve a faster distribution and more thorough enforcement of guidelines currently in force in daily health care, as well as a more efficient resource management.

Nevertheless, it was shown that WFMS can only cope in part with the requirements of health care. This is mostly due to the fact that procedures in health care are only partially subject to a mostly linear sequence of steps with a limited number of well defined decision points. In fact, medical activity is rather subject to a plurality of intellectual decision situations, in which the criteria for the selection of a diagnostic or a therapeutic alternative can be formulated only in a fuzzy or diffuse manner. In such situations, the rule-based formalisms used in a WFMS often fail. Therefore, workflow management systems only present a part of the support of work and decision procedures in health care, especially if simply structured procedures and resource management are involved.

### Decision Support Systems

Decision support systems embody experts' knowledge of a particular domain and aim at providing aid in decision situations by means of inference mechanisms and processed background knowledge. In the clinical everyday work, the physician constantly needs to take decisions for example while establishing a diagnosis, when selecting diagnostic tests, in the assessment of a patient's prognosis and the selection among different therapy alternatives. The physician needs to consider all patient data known to him as well as the current valid knowledge.

Early attempts to gather medical expertise in rule-based systems have proven themselves as failures, because generally medical interrelations are known within certain probabilities, only, and do not lend themselves to be mapped in the form of strict sets of rules. For this reason, for the better part of the Decision Support Systems of today are based on probabilistic methods, in which in particular the application of the Bayes theorem plays an important role. With the aid of the Bayes theorem, the conditional probability P(D|S) for the existence of a hypothesis D (diagnosis) assuming evidence S (observed symptom) can be calculated, if the unconditional a-priori probabilities for D and S and the conditional causal probability P(S|D) that D causes an event S are known:

P(D|S)=P(D)*P(S|D)/P(S).

Yet, in this form, the application of the Bayes theorem is hardly applicable, since besides the need to know the a-priori probabilities P(Dᵢ) and P(Sⱼ) for all potential diagnoses Dᵢ and single symptoms Sⱼ, the causal probabilities P(S₁, . . . , Sₙ|Dᵢ) for a combination of symptoms S₁, . . . , Sₙ under the assumption of a disease Dᵢ has to be established. The number of the probabilities to determine therefore increases exponentially with the number of possible symptoms and diseases. The entirety of all these probabilities is called Joint Probability Distribution.

Exploiting assumptions of statistical independence among symptoms and by focussing on direct causal relations the Joint Probability Distribution can be reduced to a significantly smaller set of base probabilities. These simplifications may be represented graphically in the form of so-called Bayes Networks or Belief Networks. These are acyclic graphs, in which nodes represent single random variables (symptoms, diagnosis) and directed edges represent direct interrelations between a cause and an effect. For each node a local probability distribution needs to be stated, only. A Bayes Network is a compact but complete representation of the Joint Probability Distribution, i.e. a conditional probability may be calculated for each symptom combination and diagnosis.

Changes to the probabilities of a Bayes Network result in an update of the complete Joint Probability Distribution und make possible a couple of inference techniques that are very useful in practice.

### Diagnostic Conclusion:

The patient data known at a specific instant (observed symptoms) are introduced in the Bayes Network by setting the a-priori probability accordingly (for example to the value of “1”, if the symptom is positively present or has been unmistakeably observed). This leads to an (direct or indirect) update of the diagnosis nodes linked to these symptoms. Accordingly, some diagnoses are confirmed, while others are discarded.

### Causal Conclusion:

A certain diagnosis is assumed to be true, that is its a-priori probability for the corresponding diagnosis node is set to 1. This results in an adjustment of probabilities for the symptom nodes. This makes it possible to narrow the search for symptoms in the patient on those symptoms that have become particularly likely in order to verify or falsify the hypothesis of the diagnosis.

### Sensitivity Analysis:

The significance of symptoms can vary greatly depending on their specificity. By means of a specificity analysis those symptoms can be determined, that contribute a particularly large gain of information for the confirmation of a diagnosis. Hence, the symptom node having the largest influence on a diagnosis node will be searched. Information regarding the presence or non-presence of a symptom usually requires the execution of diagnostic tests (e.g. an ECG examination or a computer tomography), that is associated with certain costs and risks. When associating symptom nodes with the diagnostic tests required to verify that symptom, the sensitivity analysis may in addition provide a cost-benefit weighting.

Workflow management systems (WFMS) are primarily used for resource management and the procedure control on an organisational layer. However, they provide only little support in a specific decision situation. Decision support systems (DSS) on the other hand are in general conceived as stand-alone systems, i.e. they incorporate primarily medical expertise, while information regarding the organisational context, which they are part of, is not considered in the conclusions and recommendations.

The present invention relates to an integrated workflow and decision support system that utilizes the strong points and assets of both the WFMS component and the DSS component in a synergetic way. In doing so, the WFMS component and the DSS component mutually use the respective offered services and exchange data. Compared to a genuine WFMS an improved support of the decision is possible. In exchange, the DSS can take into account the current organisational context.

Compared to workflow management-based solutions, the advantages of the invention are the consideration of fuzzy, probabilistic knowledge (as opposed to hard-coded and deterministically pre-defined procedures in workflow management systems), resolution of decision points at run time in an automatic or semi-automatic manner, and resolution of resource conflicts in the case of several concurrent workflow instances.

Compared to Bayes networks the present invention is advantageous in that it considers information regarding resource availability in an automatic manner. It also supports automatic data provision about observed evidence by the workflow management system, and the incorporation in multi-step, concurrent strategies by means of the planning and scheduling feature of the workflow management system.

One embodiment of the present invention is directed to a health care data management system comprising a workflow management system and a decision support system. The decision support system comprises a probabilistic expert system for medical advice and is arranged to create a query to be sent to the workflow management system. It is also arranged to receive a corresponding answer determined by the workflow management system. This answer comprises entity allocation data relating to the allocation of an entity handled by the workflow management system. Furthermore, the decision support system is arranged to utilize the data as probabilistic input variable(s) for the expert system.

The workflow management system may be understood as a tool focused on organisational tasks within a health care facility, while the decision support system may be understood as an aid for e.g. a physician assisting in taking medical decision such as diagnosing, establishing a treatment plan or the like. Although in the following reference is made to diagnosis tasks, it is to be understood that, where applicable, steps of a treatment plan may be referred to, as well. General expert systems are computerized tools designed to enhance the quality and availability of knowledge required by decision makers. A typical expert system comprises at least a knowledge base and an expert system shell. Knowledge bases are traditionally described as large systems of “if-then” statements. A probabilistic expert system typically comprises a knowledge base that is based on probabilities, which put different pieces of information into relation, rather than simple binary (yes or no) rules. An expert system for medical diagnosis may be designed to accept as input a number of symptoms that were detected with a patient and to provide a single or a plurality of possible diagnoses, which are common to exhibit that symptom combination. The diagnoses may be accompanied by a confidence level so that the physician may assess the probability of a diagnosis established by the expert system. The query that is sent from the decision support system to the workflow management system may contain an inquiry concerning the medical record of the patient that is being diagnosed. However, the medical record does not need to be stored with the workflow management system, but may be provided by some other means, such as on a chip card or magnetic card or some other means. The query does however contain an inquiry concerning data managed by the workflow management system. Typically these data comprise allocation data or schedules for certain entities within the health care facility, such as radiology devices, rooms, or specialised surgeons. Accordingly, the decision support system queries the workflow management system about the availability of certain entities and the cost of using these entities, knowing that “cost” does not only comprises the actual operating costs but also those that occur, if the schedule of an entity needs to be changed, which leads to rescheduling other patients. Changing an entity's schedule may be necessary if one patient undergoes an emergency condition which requires quick action. Furthermore, “cost” may also refer to the danger that is tied to certain diagnostic methods, such as exposure to radiation. The answer sent from the workflow management system to the decision support system may then be used as input for the expert system, which evaluates the same and takes it into account for the decision that the decision support system will eventually suggest to the user. The one or more input variables are probabilistic, which means that they serve as an input for a probabilistic method. They may be, but do not need to be, accompanied by a confidence level indicating the reliability of the provided data. Examples for such variables are the queue time for an entity, which may be set to infinity if the entity is not available at all.

The health care data management system according to the present invention is advantageous in that probabilistic, somewhat “fuzzy” knowledge contributes to the control of the workflow management system. Another advantage is that decision points in the workflow may be resolved in an automatic or at least semi-automatic manner. Furthermore, it is advantageous to consider information concerning the availability of certain entities in the decision making process, since there may be alternatives that are almost equally as effective.

In a related embodiment, the expert system of the health care data management system is arranged to determine a set of relevant medical actions on the basis of the input variable(s) and/or a patient's medical data. The medical actions are intended to be managed by the workflow management system and to provide further medical data. The set of medical actions may be ordered in a ranking order according to a probabilistic impact of each of the medical actions on a confidence level of a medical diagnosis or a medical treatment plan.

Depending on whether the physician is establishing a diagnosis for a patient or a treatment plan, the medical action referred to above is a diagnostic action or a therapeutic action. Furthermore, a medical action may also relate to a prognosis. When trying to diagnose the disease a patient is suffering from, a physician often needs to conduct a plurality of diagnostic actions or tests on the patient, which may be more or less elaborate. However, with each conducted test, the evidence of the patient's health state increases. The result of one test also influences which tests to conduct next. In order to reduce the number of tests and/or the necessary time, it is desirable to conduct those tests first, which narrow the spectrum of possible diagnoses most efficiently. Therefore, the set of possible actions is preferably ranked in such an order that the physician can easily assess the prospects of each new test. Of course, the patient's medical data determines primarily, which diagnostic action needs to be undertaken next. Nevertheless, in those cases, in which two or even more diagnostic actions have about the same diagnostic benefit, the availability of the entities that are needed to conduct the corresponding tests may be decisive. A diagnostic action is managed by the workflow management system in that it directs the actions that need to be performed by corresponding personnel (such as a nurse, radiology assistant, laboratory staff etc.). In general, the action itself is still performed by health care personnel, although simple and riskless actions (e.g. having the patient fill out a standard questionnaire) may be conducted by appropriate periphery of the workflow management system in the future. The advantage is that the flexibility in responding to a patient's diagnostic needs is increased. This often results also in an accelerated throughput time for the patient. Instead of arbitrarily changing the diagnostic schedule of a patient due to unforeseen events (e.g. capacity overload at a radiology device), the physician can choose from a number of alternatives, which are regarded by the health care data management system as almost as efficient as the (not immediately available) optimal alternative.

When deciding about therapeutic actions, the decision support system may provide suggestions for such therapeutic actions. It may also provide a prognosis or several prognoses under the assumption that the suggested therapeutic action is carried out in the suggested manner. To cite an example, the prognosis could describe the survival time under the assumption of a certain cancer treatment in a probabilistic manner.

In a related embodiment, the workflow management system of the health care data management system is arranged to handle a plurality of workflow instances. Each workflow instance corresponds to a patient's medical attendance. The health care data management system is arranged to resolve an entity allocation conflict between at least two workflow instances. The conflict resolution is achieved by cancelling or rescheduling a subsequent medical action to be performed in the context of one of the at least two workflow instances that is involved in the allocation conflict. Then the system reverts to a medical action that is ranked next in the ranking order and has a sufficiently high probabilistic impact on the confidence level of the medical diagnosis or on the efficiency of a medical treatment.

An entity allocation conflict may arise, if an entity is allocated to a patient for a certain time, while another patient urgently needs to occupy the same resource at the same time. The medical attendance for both patients is managed within the workflow management system, so that the workflow management system is the component that is capable of detecting the presence of a conflict. The question, which patient should be favoured, is preferably answered by the decision support system, which is capable of taking into account medical expertise. This helps in making a well-founded medical decision about rescheduling or cancelling a certain medical action for one of the patients. As pointed out above, for each patient several possible steps or actions to be performed next may exist. Although one of these actions is favoured in terms of medical and/or diagnostic benefit, those actions ranked behind the favoured action may still be of satisfying benefit. For a diagnostic action this benefit is determined among others by the probabilistic impact on the confidence level of the medical diagnose. It should be noted that a particular diagnostic action may have strong probabilistic impact on the confirmation or the invalidation of one diagnosis, but may have a probabilistic impact close to zero for another diagnose. However, in the course of the medical attendance and with every new diagnostic action performed, one diagnosis is prone to confirm itself, while the other is prone to invalidate itself. For efficiency reasons, only those diagnoses that, after a number of tests, still have a relatively high confidence level may be considered.

In a further embodiment of the present invention, an interface is connectable to a workflow management system and to a decision support system and arranged for use in a health care data management system as described above. Such an interface may be implemented in hardware or in software or in a combination of both. It may comprise a component that is arranged to be installed at the workflow management system's site of the health care data management system. In an analogue manner, the interface may comprise a component that is arranged to be installed at the decision support system's site of the health care data management system. Furthermore, the interface may comprise a connection between these two components, as the case may be over a secured channel. The interface according to the present invention may put into relation an existing workflow management system and an existing decision support system. Preferably, the interface adds appropriate query data to a query of either one of the existing systems and forwards the obtained answer data. Ideally, only marginal changes need to done to the existing systems, so that the interface would be almost transparent for the existing systems. For example, the interface may act as a local or remote user of the workflow management system or of the decision support system. The advantage is that the benefit of the invention can be exploited without the need to install a complete new system, but by building on the existing structure. Furthermore, the interface may also act as an interpreter between a workflow management system of one manufacturer and the decision support system of another manufacturer. To this end, the interface may translate a query formulated according to one manufacturer's standard to a query formulated according to another manufacturer's standard. Another advantage yet is that the interface may communicate between a medical equipment, such as a computer tomography or a magnetic resonance imaging device, and a workflow management system and/or a decision support system. For example, if a physician is unsure about a certain apparent lesion in an image displayed at a computer tomography workstation, he may connect himself/herself to a decision support system and enter the properties of the lesion (size, colour, shape, location etc.). Eventually, he or she may even upload the image for comparison to images in a large database. Once an initial suspect is confirmed, the physician may schedule further tests on other devices, which is preferably done by means of a workflow management system. The health care data management system may be of assistance by suggesting one or several possible confirmation tests.

A further embodiment of the present invention is directed to a computer program product for an interface in a health care data management, comprising:

a computer readable medium having computer readable program code embodied thereon, the computer readable program code comprising:

computer readable program code, which implements an interface to a workflow management system;

computer readable program code, which implements an interface to a decision support system comprising a probabilistic expert system,

wherein the decision support system interface is arranged to receive a query from the decision support system and to forward the query to the decision support system interface for subsequent forwarding to the workflow management system, wherein the workflow management system interface is arranged to receive a corresponding answer from the workflow management system, the answer comprising entity allocation data relating to the allocation of an entity handled by the workflow management system and to forward the answer to the decision support system interface for subsequent forwarding to the decision support system and using the comprised data as probabilistic input variable(s) for the expert system.

A computer program product as described above may be used to install a software implemented interface on a server or computer within a computer network of a health care facility. This server or computer may be one of those used for the workflow management system and/or the decision support system. In the alternative, the software implemented interface may be installed on an independent server or computer. The advantage of a computer program product as described above is that it may be used to upgrade an existing computer installation of a health care facility in a relatively simple way in order to arrive at a health care data management system that supports interaction of workflow management and decision support. The advantage of a modular structure comprising computer readable program code, which implements an interface to a workflow management system and computer readable program code, which implements an interface to a decision support system, makes it possible to keep the interface versatile in terms of interoperability of different subsystems originating from different vendors. Such an interface may be built using an object request broker, such as the Common Object Request Broker Architecture (CORBA), or some similar middleware product.

In a related embodiment, the workflow management system interface and the decision support system interface of the computer program product are arranged to forward a set of relevant medical actions from the decision support system to the workflow management system, the medical actions being intended to be managed by the workflow management system and to provide further medical data, the set of medical actions being ordered in a ranking order according to a probabilistic impact of each of the medical actions on a confidence level of a medical diagnosis or on the efficiency of a medical treatment.

The term “relevant medical actions” refers to those actions that have a non negligible probabilistic impact on the outcome of a diagnosis or a treatment. These may be grouped in a set and ordered according to the value of their respective probabilistic impact. In a way, this set corresponds to a list of those actions, which the decision support system has classified as most useful, if performed in the next step of the patient's attendance. Since the set is ordered, the entry at the top of the list may be understood, in the context of a diagnosis, as the most useful (i.e. informative) diagnostic action. It should be noted that the confidence level of a diagnosis reflects the reliability of that diagnosis. The physician usually strives to arrive at a single diagnosis having a high confidence level (e.g. close to 100%), while the second-best diagnosis has a very low confidence level already. As long as there are two diagnoses having about equally high confidence level, the physician should usually confirm one of the diagnoses and discard the other by means of further test. The ordered set of diagnostic actions forwarded to the workflow management system is evaluated by the workflow management system. The workflow management system determines the availability of the different required resources or entities. It may translate these into a value corresponding to the cost of using this entity (e.g. queue time).

In a further related embodiment, the query and/or the answer comprises data corresponding to at least two patients' medical attendances competing for allocation of one of the entities. The query and/or answer comprises a cancellation or rescheduling command for one of the subsequent actions relating to the medical attendance of one of the patients and a reverting command in favour of a medical action that is ranked next in the ranking order and has a sufficiently high probabilistic impact on the confidence level of the medical diagnosis or on the efficiency of the medical treatment. The advantage of a cancellation or rescheduling command is that this action needs not to be entered manually. Preferably, the physician in charge only needs to confirm the rescheduling or the cancellation. In a scenario, in which both patients are taken care of by two different physicians, it may be necessary to obtain the approval of the physician whose patient's medical attendance schedule is about to be rescheduled or changed. In such a case, the physician whose approval is required may be contacted by means of e.g. a pager.

A further embodiment is directed to a computer program product for a health care management system comprising an interface computer program product as described above. Instead of upgrading an already existing installation of a health care facility, the entire system may be installed as a whole, which is an option for newly constructed facilities. This has the advantage that the entire system is already tested with respect to compatibility and reliability.

In yet another embodiment of the present invention, a method for operating a health care data management system, comprises the steps of:

creating a query to be sent from a decision support system to a workflow management system;

transmitting the query to the workflow management system via an interface between the decision support system and the workflow management system;

determining an answer to the query comprising entity allocation data of an entity handled by the workflow management system;

transmitting the answer to the decision support system; and

utilizing the data as a probabilistic input variable for a probabilistic expert system comprised by the decision support system.

The advantages of such a method are substantially the same as those described for a health care data management system and/or a computer program product according to the present invention.

In a related embodiment, the method further comprises the steps of:

determining a set of promising medical actions on the basis of the input variables and/or a patient's medical data;

ranking the medical actions in a ranking order according to a probabilistic impact of each of the medical actions on a confidence level of a medical diagnosis or on the efficiency of a medical treatment;

scheduling one of the medical actions, which is ranked highest, within the workflow management system for subsequent execution.

In the step of scheduling one of the medical actions, which are part of a patient's workflow that still needs to be executed may be changed according to the ranking of medical actions. It should be noted that a temporary unavailability of an entity may be considered in the ranking in addition to the confidence level of the medical diagnosis, which takes the organisational environment (e.g. resource schedule line) into account.

In another related embodiment, the method further comprises the steps of:

handling a plurality of workflow instances within the workflow management system, each workflow management instance corresponding to a patient's medical attendance;

resolving an entity allocation conflict between at least two workflow management instances by cancelling or rescheduling a subsequent medical action to be performed in the context of one of the at least two workflow instances that is involved in the allocation conflict;

reverting to a medical action that is ranked next in the ranking order and has a sufficiently high probabilistic impact on the confidence of the medical diagnosis or on the efficiency of the medical treatment.

The advantages of such a method are substantially the same as those described for a health care data management system and/or a computer program product according to the present invention.

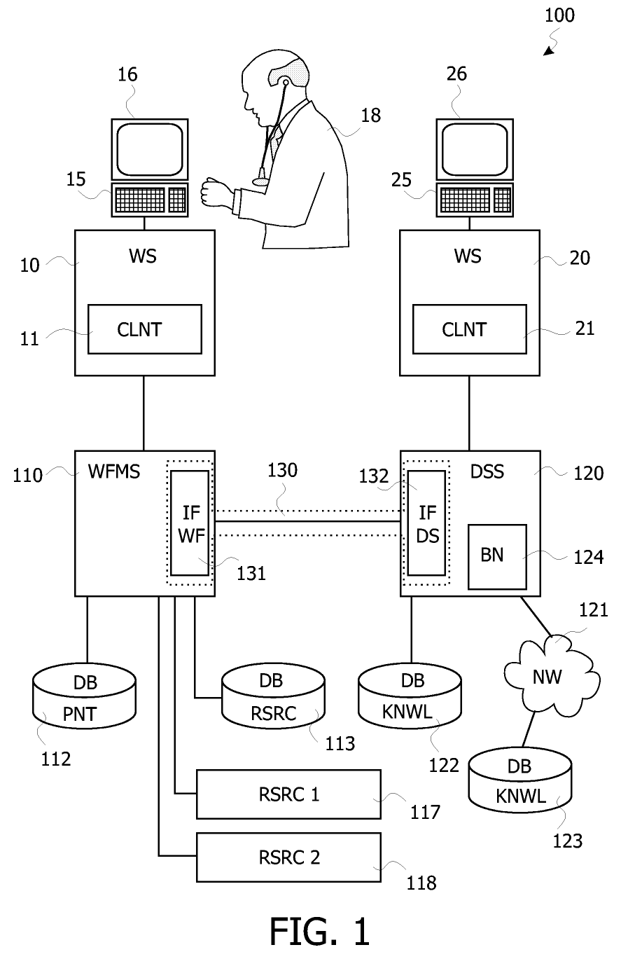

FIG. 1 is a block diagram of a health care data management system according to the present invention.

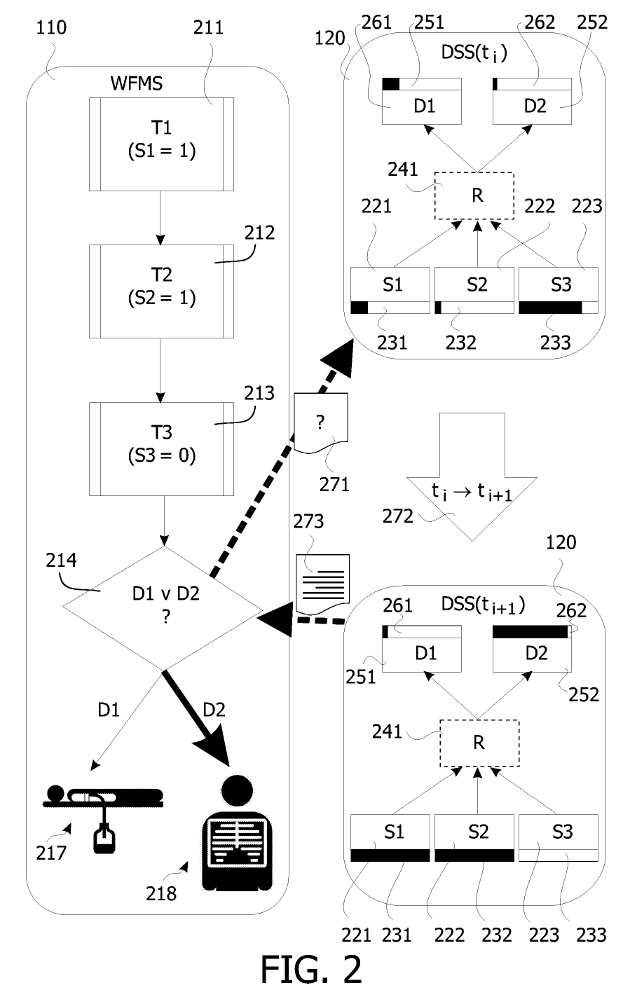

FIG. 2 is a schematic representation of the interaction between a workflow management system and a decision support system according to one embodiment of the present invention.

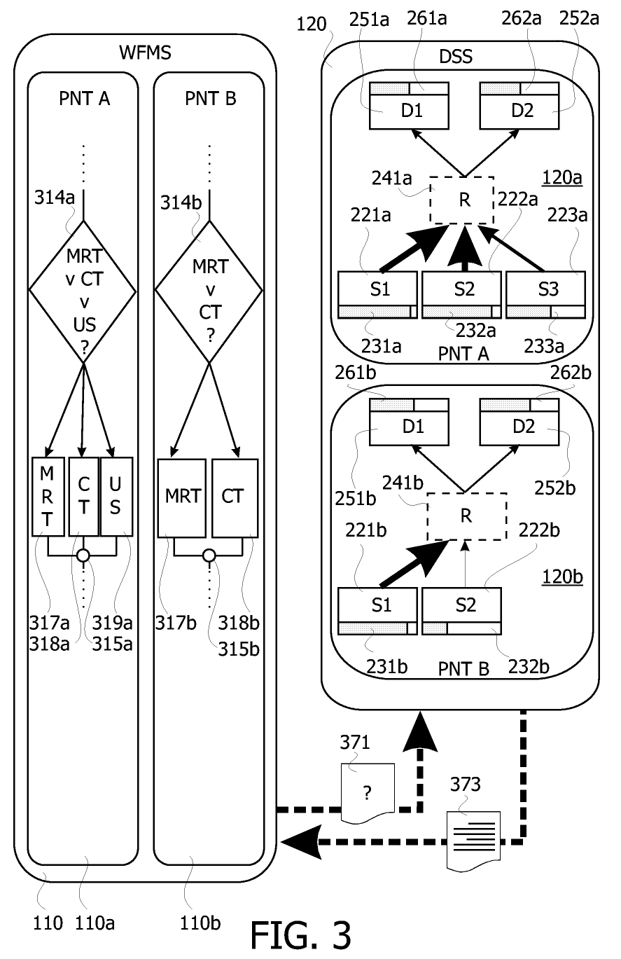

FIG. 3 is a schematic representation of the interaction between a workflow management system and a decision support system according to another embodiment of the present invention that supports concurrent workflow instances.

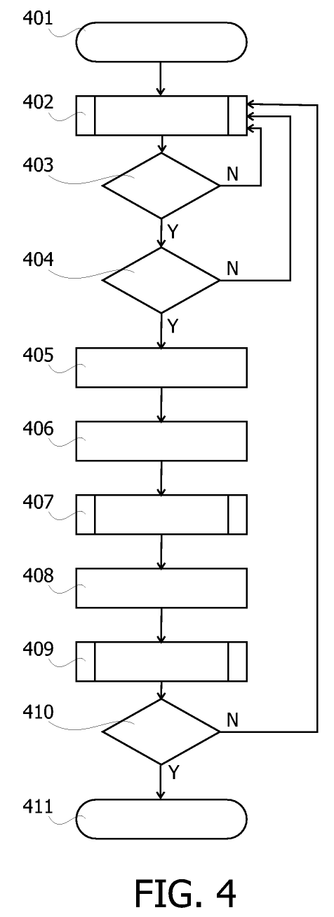

FIG. 4 is a flow chart illustrating the steps of a method according to the present invention.

FIG. 1 is a block diagram of a health care data management system 100. A workflow management system (WFMS) 110 serves as an organisational tool for example within a health care facility. Such a workflow management system manages data relating to patients, resources and the workflows according to which patients are treated in the facility. The resources comprise medical equipment, rooms, beds, drugs, and staff, to name a few. A first resource (RSRC 1) 117 and a second resource (RSRC 2) 118 are depicted in FIG. 1. Patient related data may comprise standard personal information about the patient, his medical history, diagnostic findings, and a treatment plan or medical attendance plan. Furthermore, the patient related data may comprise allocations to certain resources. Patient related data is stored in a patient data base (DB PNT) 112 that is connected to the workflow management system. Data relating to resources are stored in a resource data base (DB RSRC) 113, which is connected to the workflow management system, as well. A workstation (WS) 10 for a nurse or a physician is also connected to the workflow management system. The workstation comprises a client (CLNT) 11 for establishing a connection with the workflow management system. By means of a keyboard 15 and a monitor 16, a physician 18 may consult the workflow management system 110, for example to obtain data about a certain patient. Instead of physician 18, the workstation may also be operated by another authorized staff member, such as a nurse or a medical assistant.

Besides the workflow management system 110, a decision support system 120 is illustrated. A physician's workstation (WS) 20 is also connected to the decision support system. The workstation comprises a client (CLNT) 21 for establishing a connection with the decision support system. By means of a keyboard 25 and a monitor 26, a physician 18 may enter data into the decision support system 110, for example to obtain a diagnosis based on a patient's symptoms. Decision support system 120 is connected to the workflow management system 110 and also to an internal medical knowledge data base (DB KNWL) 122. Optionally, the decision support system is also connected to an external medical knowledge data base (DB KNWL) 123 by means of a communications network 121. External medical knowledge data base (DB KNWL) 123 may for example be provided by some national or international health care organisation. Decision support system 120 serves to assist a physician in diagnosing a patient and establishing an appropriate treatment plan. To this end, the physician enters medical findings relating to the patient, such as observed symptoms, into the decision support system. In many cases, symptoms merely hint at one or several possible diseases, so that a single symptom may not be very significant. This means that a combination of symptoms needs to be entered in order to obtain more meaningful results. While some symptoms are relatively easy to obtain by questioning the patient, the determination of other symptoms is more elaborate or sometimes even possibly harmful for the patient, as is the case for some radiology methods. Accordingly, a physician needs to carefully choose appropriate diagnostic methods in order to arrive at a reliable result. Especially the field of health care is subject to a large number of empiric studies and results, rather than simple if-then relations. Probabilistic networks are an option to cope with such a field of knowledge, because medical studies often include a statistical analysis of the underlying data. A probabilistic network may be a Bayes network, which is a finite, acyclic, directed graph depicting the causal relationships between a number of variables. The network is implemented by means of matrices specifying the probability that any variable takes a particular value given the values of its immediate causes. From these matrices, it is possible to compute the entire probability distribution for all the variables in the network. Applied to a medical expert system this means that by changing the probability of one symptom from an initial value, i.e. not yet verified, to a higher value, i.e. the symptom is present with the patient with a certain probability, every variable depending on that symptom will be changed, accordingly. It should be noted that the initial value of a symptom does not need to be zero, because the symptom may have a certain a-priori probability among the population, such as blood type AB, for example. Since the symptom may be confirmed or discarded, the probability for that symptom should be able to increase compared to the initial value, if the symptom is confirmed, and to decrease, if the symptom is discarded.

Workflow management system 110 and decision support system 120 are connected to each other via an interface 130. The interface comprises a workflow management system interface component (IFWF) 131. The interface also comprises a decision support system interface component (IFDS) 132. A standard computer network may serve as a physical support for interface 130. Such a network may also comprise connections to workstations 11 and 21. As an alternative, a direct link between workflow management system 110 and decision support system 120 may be established, especially if large volumes of data are to be transferred between both interface components 131 and 132. The interface 130 facilitates the interconnection of existing workflow management systems and decision support system by providing a conversion and/or adaptation between a workflow management system's protocol and a decision support system's protocol.

FIG. 2 is schematic representation of the interaction between a workflow management system 110 and a decision support system 120. In the context of this invention, a question is defined as being issued by the workflow management system 110 and directed to the decision support system 120. A query, on the other hand, is defined as being established by the decision support system 120 and directed to the workflow management system 110. A response is defined as being established by the decision support system 120 and directed to the workflow management system 120. On the other hand, an answer is defined as being established by the workflow management system 110 and directed to the decision support system 120. Within the workflow management system 110 a part of a workflow corresponding to a single patient is illustrated. The workflow comprises three tests or diagnostic actions 211 (T1), 212 (T2), and 213 (T3) that are carried out by the physician or some qualified staff member on the patient. Three symptoms S1, S2, and S3 correspond to one of the tests T1, T2, and T3, respectively. The test results show that symptoms S1 and S2 are unmistakably present, since both symptoms are set to 1. Symptom S3 on the other hand, having been set to 0, is unmistakably not present. Each result could have a value between 0 and 1 in order to reflect a test result that is not entirely reliable. After the three tests, decision point 214 is reached, in which needs to be decided what kind of test or treatment the patient should undergo next. So far, the diagnostic result could be narrowed down to two diagnoses D1 and D2. However, the three results of the three tests T1, T2, and T3 have not yet been exploited. In order to do so, the combination of symptoms S1, S2, and S3 is transmitted to the decision support system 120. To this end, the workflow management system creates a question 271 for the decision support system, incorporating the test results, the medical history of the patient etc. These data are input into the decision support system 120 at a time tᵢ, which is indicated by DSS(tᵢ) in FIG. 2. Inside of the decision support system 120, a field for each symptom is found. Symptom S1 is destined to go into field 221, symptom S2 is destined to go into field 222, and symptom S3 is destined to go into field 223. Confidence indicators 231, 232, and 233 are depicted in order to illustrate the continuous nature of the value of a symptom. As depicted, confidence indicators 231, 232, and 233 still are set to the previous run of the decision support system, in which the symptoms S1, S2, and S3 were involved. The probabilistic expert system is illustrated as rules block 241 (R), which has inputs connected to the fields of the three symptoms S1, S2, and S3, and which has outputs connected to the fields 251 and 252 of the diagnoses D1 and D2. Again, confidence indicators 261 and 262 illustrate the calculated confidence of each of the diagnoses D1 and D2 in a graphical manner. As soon as the values of the symptoms S1, S2, and S3 have been loaded to the corresponding fields 221, 222, and 223, the expert system 241 is ready to be updated. This happens while advancing to the next instance tᵢ₊₁, which is indicated by update arrow 272. Beneath arrow 272 the updated decision support system DSS(tᵢ₊₁) is depicted. Confidence indicators 231, 232, and 233 have been updated with the corresponding values for the symptoms S1, S2, and S3. The expert system 241 has evaluated the symptoms and come to the conclusion that diagnosis D1 is rather unlikely, while diagnosis D2 is highly probably, as can be seen in the updated confidence indicators 261 and 262. This result is passed to the workflow management system by means of a response 273. Response 273 determines the further processing within the workflow starting from decision point 214. As pointed out above, diagnosis D2 is believed to be probable. In order to confirm this diagnosis, the response 273 also includes a suggestion for a subsequent diagnostic action. In this case, as an example only, an x-ray examination 218 is suggested as a confirmation of diagnosis D2. In case diagnosis D1 would have been retained, a blood test 217 would be used to confirm this diagnosis.

FIG. 3 shows another operating mode of an embodiment of the present invention. This operating mode addresses the problem of allocating scarce resources to a plurality of competing demanders. Again, a workflow management system 110 is depicted on the left side of the drawing. The workflow system 110 is capable of managing a plurality of workflow instances, each workflow instance corresponding to the medical attendance of a particular patient. In the represented scenario, workflow instance 110a controls the medical attendance of a patient A (PNT A) and workflow instance 110b controls the medical attendance of a patient B (PNT B). For sake of clarity, only two patient workflow instances 110a and 110b are shown in FIG. 3. Both workflow instances 110a and 110b have in common that, after some previous processing, they each arrive at a decision point 314a and 314b, respectively. The expression “MRT v CT” translates to “MRT OR CT”. The two decision points 314a and 314b resemble each other in that both include an magnetic resonance tomography (MRT) examination and a computer tomography (CT) examination as possible alternatives. The MRT examinations are referred to by 317a and 317b, respectively. The CT examinations are referred to by 318a and 318b, respectively. A difference between the decision points 314a and 314b of workflow instances 110a and 110b is that decision point 314a belonging to the workflow instance for patient A additionally includes an ultrasound (US) examination 319a as a possible alternative. Another point that decision points 314a and 314b have in common is that they both become active within a close temporal relationship. More particularly, their respective activity periods are overlapping, which means that both are simultaneously confronted with taking a respective decision at least at some instant during their respective activity periods. Once a decision has been taken, the corresponding action, i.e. MRT, CT, or US examination, will be scheduled by the workflow management system for execution, provided that the required resources are available. After the chosen action has been performed, each workflow instance 110a and 110b is re-converged by means of a respective OR-join 315a, 315b, after which the two workflow instances continue.

The resolution of the two decision points 314a and 314b is now described. In the general case, one of the decision points 314a, 314b is attained by the respective workflow instance before the other decision point, say decision point 314a. In order to progress further, a question 271 (FIG. 2) corresponding to the resolution of decision point 314a is created and sent to the decision support system 120. Within the question, allocation data of the entities that are related to the three proposed examination methods are also sent to the decision support system, such as a queue time. The decision support system suggests pursuing one of the three actions. If the entity corresponding to the chosen action has time slots available either at once or in the near future, the corresponding action may be performed without any conflict with other workflow instances. This behaviour corresponds by and large to the operating mode illustrated in FIG. 2. In a more complicated case however, if the queue time is sufficiently long to allow a second workflow instance 110b to reach its respective decision point 314b while workflow 314a has not yet been cleared to continue with one of the actions 317a, 318a, or 319a, then workflow instance 110b enters into competition with workflow instance 110a for the MRT and CT resource entities. Applying a simple first-come-first-served scheduling has a number of shortcomings limiting its use in health care situations. Therefore the present invention proposes to send a new question 317 from the workflow management system to the decision support system whenever the state of the workflow management system changes, especially whenever another workflow instance makes demands on resources that are already solicited. This question 317 contains all the medical data for all involved patients that the decision support system needs to make a decision. In the alternative, the data corresponding to a single patient could be sent in a separate question, leaving it up the workflow management system to sort the answers issued by the decision support system in order to arrive at ranking order for the workflow instances. Within the decision support system 120 an expert system instance 120a for patient A and an expert system instance 120b for patient B is illustrated. The elements illustrated within the two expert system instances 120a and 120b were already described in the context of FIG. 2, with the difference that in FIG. 3 their respective affiliations to patient A or patient B are indicated by means of lower case letters a and b. Symptom S1 can be detected by means of an MRT examination, symptom S2 can be detected by means of a CT, and symptom S3 can be detected by means of a US examination. It should be noted that symptom S1 may be different for patient A and patient B. They are linked by the fact, that they may be both detected by means of an ultrasound examination. In contrast to FIG. 2, the purpose of invoking the expert system is not to find a correct diagnosis right away, but to find out the most efficient diagnostic actions in the first place. For this reason, the confidence indicators for the symptoms 231a, 232a, 233a, 231b, 232b, and 233b are shaded grey in order to indicate their temporal inactivity. The same holds for the confidence indicators for the diagnoses 261a, 262a, 261b, and 262b. In the context of FIG. 3, the ability of a probabilistic expert system to evaluate the influence or “impact” of certain symptoms on a diagnosis is exploited. The different influences are indicated by arrows having different thickness. In the illustrated example, the diagnosis of patient A is strongly influenced by symptoms S1 and S2. Symptom S3 is less influential. For patient B, the only symptom having influence on the diagnosis is a symptom S1, while symptom S2 is virtually negligible. These results are sent back to the workflow management system by means of an answer 373. The workflow management system recognizes that an MRT is useful for patient A and patient B. Yet, patient A may also undergo a CT with almost equally high diagnostic benefit. Under the constraint that there is no alternative for patient B, the workflow management system, under reference to the decision support system, may reschedule patient A to attend a CT instead of the originally intended MRT examination.

FIG. 4 shows a flow chart of a method according to the present invention. The method starts at step 401. Step 402 combines a number of steps performed in standard workflow management with the exception of decision points, especially those requiring some medical expertise for their resolution. In step 403 a determination is made, whether the workflow has reached a decision point. If not (branch “N”), then the workflow loops back to step 402 for standard workflow processing. If it is determined that a decision point has been reached in the workflow, then the it is proceeded to the next step 404 via the branch labelled “Y”. In step 404 a determination is made, whether the decision in the workflow requires medical expertise. If not (branch “N”), then the workflow management system loops back to step 402. If medical expertise is required (branch “Y”), the method proceeds to step 405, in which a question is formulated based on available and pertinent data in the workflow management system. The question is destined to be sent to the decision support system. Step 406 is a step, in which the question is sent to the decision support system, thereby querying the same. At step 407, the decision support system evaluates the question and draws up an answer that is to be sent back to the workflow management system. This may be done preferably be means of a probabilistic expert system, such as a Bayes network, which is a component or an add-on of the decision support system. In step 408, the answer corresponding to the question is received at the workflow management system. Essentially, there are two principal alternatives of what this answer contains: a diagnosis or an action, the action relating to further tests on the patient or a medical treatment plan. The workflow management system takes up the suggestion and creates or changes the workflow ahead accordingly. In step 409, the action ordered by the decision support system or an action that is determined by the workflow management system on the basis of a determined diagnosis and pre-defined treatment plans is carried out by the workflow management system. After completion, the method proceeds to step 410, in which it is determined, if the workflow continues or if it has reached its end. In the latter case, the method proceeds to step 411 marking the end of the method. In the former case, the method loops back to step 402 and continues with standard workflow processing.

It lies within the nature of the described health care data management system that it may be looked at from more than one perspective. This is due to the distributed nature of the system, having a workflow management system on one side and a decision support system on the other. In particular, either sub-system may query or question the other sub-system on its own initiative, depending on the organisation and the preferences of the health care facility. Notwithstanding, the principles of its structure and operation remain unchanged.

It should be emphasized that the above-described embodiments of the present invention are possible examples of implementations, merely set forth for a clear understanding of the principles of the invention. Many variations and modifications may be made to the above-described embodiments that fall within the scope of the present invention, which is defined by the accompanying claims. In particular, any feature described in one of the claims of the system, interface, computer program product and/or method category, may be combined with any other feature or feature combination. Although described in terms of a health care data management system, the person skilled in the art will readily acknowledge that a combined workflow management and decision support system is applicable in other domains, as well, for example for customer relation management (CRM) with integrated trouble shooting functionality for internet providers or for damage event processing in an insurance.

1. Health care data management system, comprising
a workflow management system and
a decision support system,
the decision support system comprising a probabilistic expert system for medical advice and being arranged
to create a query to be sent to the workflow management system,
to receive a corresponding answer determined by the workflow management system, said answer comprising entity allocation data relating to the allocation of an entity handled by the workflow management system, and
to utilize said data as probabilistic input variable(s) for the expert system.

2. Health care data management system according to claim 1, wherein the expert system is arranged to determine a set of relevant medical actions on the basis of said input variable(s) and/or a patient's medical data, said medical actions being intended to be managed by the workflow management system and to provide further medical data, said set of medical actions being ordered in a ranking order according to a probabilistic impact of each of said medical actions on a confidence level of a medical diagnosis or on the efficiency of a treatment plan.

3. Health care data management system according to claim 2, wherein the workflow management system is arranged to handle a plurality of workflow instances, each workflow instance corresponding to a patient's medical attendance, and wherein the health care data management system is arranged to resolve an entity allocation conflict between at least two workflow instances by cancelling or rescheduling a subsequent medical action to be performed in the context of one of said at least two workflow instances that is involved in the allocation conflict and reverting to a medical action that is ranked next in said ranking order and has a sufficiently high probabilistic impact on the confidence level of the medical diagnosis or on the efficiency of a medical treatment.

4. Interface connectable to a workflow management system and to a decision support system and arranged for use in a health care data management system according to claim 1.

5. Computer program product for an interface in a health care data management, comprising:
a computer readable medium having computer readable program code embodied thereon, the computer readable program code comprising:
computer readable program code, which implements an interface to a workflow management system;
computer readable program code, which implements an interface to a decision support system comprising a probabilistic expert system,
wherein the decision support system interface is arranged to receive a query from the decision support system and to forward the query to the decision support system interface for subsequent forwarding to the workflow management system, wherein the workflow management system interface is arranged to receive a corresponding answer from the workflow management system, said answer comprising entity allocation data relating to the allocation of an entity handled by the workflow management system and to forward the answer to the decision support system interface for subsequent forwarding to the decision support system and using said comprised data as probabilistic input variable(s) for the expert system.

6. Computer program product of claim 5, wherein the workflow management system interface and the decision support system interface are arranged to forward a set of relevant medical actions from the decision support system to the workflow management system, said medical actions being intended to be managed by the workflow management system and to provide further medical data, said set of medical actions being ordered in a ranking order according to a probabilistic impact of each of said medical actions on a confidence level of a medical diagnosis or on the efficiency of a medical treatment.

7. Computer program product of claim 6, wherein said query and/or said answer comprises data corresponding to at least two patients' medical attendances competing for allocation of one of said entities, said query and/or answer comprising a cancellation or rescheduling command for one of said subsequent actions relating to the medical attendance of one of said patients and a reverting command in favour of a medical action that is ranked next in said ranking order and has a sufficiently high probabilistic impact on the confidence level of the medical diagnosis or the efficiency of the medical treatment.

8. Computer program product for a health care management system comprising an interface computer program product according to claim 5.

9. Method for operating a health care data management system, comprising the steps of:
creating a query to be sent from a decision support system to a workflow management system;
transmitting the query to the workflow management system via an interface between the decision support system and the workflow management system;
determining an answer to said query comprising entity allocation data of an entity handled by the workflow management system;
transmitting said answer to the decision support system; and
utilizing said data as a probabilistic input variable for a probabilistic expert system comprised by said decision support system.

10. Method according to claim 9, further comprising the steps of:
determining a set of promising medical actions on the basis of said input variables and/or a patient's medical data;
ranking said medical actions in a ranking order according to a probabilistic impact of each of said medical actions on a confidence level of a medical diagnosis or on an efficiency of a medical treatment;
scheduling one of said medical actions, which is ranked highest, within said workflow management system for subsequent execution.

11. Method according to claim 10, further comprising the steps of:
handling a plurality of workflow instances within said workflow management system, each workflow management instance corresponding to a patient's medical attendance;
resolving an entity allocation conflict between at least two workflow management instances by cancelling or rescheduling a subsequent medical action to be performed in the context of one of said at least two workflow instances that is involved in the allocation conflict;
reverting to a medical action that is ranked next in said ranking order and has a sufficiently high probabilistic impact on the confidence of the medical diagnosis or on the efficiency of the medical treatment.
